(19) United States
(12) Patent Application Publication
(10) Pub. No.: US 2024/0304109 A1
(43) Pub. Date: Sep. 12, 2024

(54) Card Game for Improving Spelling Skills and Method of Playing the Same

(71) Applicants: Leitauria Hopkins, Gainesville, GA (US); Javonna Blaize, Hollis, NY (US)

(72) Inventors: Leitauria Hopkins, Gainesville, GA (US); Javonna Blaize, Hollis, NY (US)

(21) Appl. No.: 18/351,063

(22) Filed: Jul. 12, 2023

Related U.S. Application Data
(60) Provisional application No. 63/451,050, filed on Mar. 9, 2023.

(51) Int. Cl. G09B 19/22

(52) U.S. Cl. CPC G09B 19/22

(57) ABSTRACT

The present invention relates to an educational game for learning and improving spelling ability and providing fun and entertainment. The game improves competitiveness and creates a sense of urgency. The game includes a playing set that includes playing cards with a holder, awards, a timer, and a buzzer. The playing cards have words printed on them that are spelled correctly by players to win the game. To play the game, a player picks a card, announces the word, and starts the timer. One of the other players spells the word within the allotted time and then it is determined if the spelling is correct or not. If the spelling is correct, then the player who spelled out the word wins otherwise, the turn is passed to another player.

### CROSS-REFERENCE TO RELATED APPLICATION

The present application claims priority to, and the benefit of, U.S. Provisional Application No. 63/451,050, which was filed on Mar. 9, 2023, and is incorporated herein by reference in its entirety.

### FIELD OF THE INVENTION

The present invention relates generally to the field of educational tools and games. More specifically, the present invention relates to a game that provides fun and entertainment while allowing players to improve their spelling skills. The game can be played by any number of players, individually, or in groups or teams. The game includes a set that provides a plurality of playing cards with each card having a different spelling word printed on it allowing a user to call out or enunciate the word and another player then attempts to spell the word. The game offers medals or prizes to winners and uses a timer and buzzer to increase competitiveness and urgency of each round of the game. Accordingly, the present disclosure makes specific reference thereto. Nonetheless, it is to be appreciated that aspects of the present invention are also equally applicable to other like applications, devices and methods of manufacture.

### BACKGROUND

By way of background, the process of learning new information and skills by people of all ages has been historically accomplished through the use of varying methods and techniques. Learning a language, requires the appreciation and understanding of new words and how the words are spelled. This process has been an integral part for teaching people, as language is a fundamental medium used for communication. People use a variety of methods for learning languages, words, pronunciation and spelling. Understanding how to correctly spell a word is important as it facilitates communication, enunciation, and supports activities such as learning to read. Being able to spell words correctly helps to make people more confident and to appear more intelligent. People often engage in fun ways to master language skills, improve their vocabulary, and learn new words as such activities may otherwise seem dull. While one may be readily able to speak the word, the correct spelling of a word can be difficult for people to grasp. Language games typically focus on learning the language through individual words which can then be used to form phrases and sentences. The spelling games available have not been particularly effective in allowing people to learn and retain the correct spelling of words. The spelling games that are in the market do not evoke competitiveness, socialization and entertainment among players and thus may not be useful in achieving the desired result. People therefore want a spelling game that offers entertainment and a sense of competitiveness, thereby allowing the participants to play the game and learn and remember the correct spellings of words they encounter while involved in the game.

Many spelling games allow an individual to play and learn the spelling alone, such as by forming a new word by moving letters of the alphabet on a board. However, such games do not allow for engagement or interaction between players and their interest in the game can wane as players are not subject to a time limit to complete the spelling of a word and as a result, are not particularly effective in obtaining a particular educational result. As such, people desire a spelling game that can be played by friends and family as an educational game.

Language games do not usually invoke a sense of urgency for spelling a word and thus do not force people to try to spell a word quickly. Further, educational games are not known to provide medals, awards, or any other type of reward to the winner. A game that can create a sense of urgency and enables winners to win prizes is desired by people to learn spelling and new words to increase their vocabulary.

Therefore, there exists a long-felt need in the art for an educational game that allows people of all ages to learn to spell. There is also a long-felt need in the art for a spelling game that provides an exciting game for people to improve their skills while competing with others. Additionally, there is a long-felt need in the art for an educational game that invokes urgency, competitiveness, and a desire to correctly spell words. Moreover, there is a long-felt need in the art for a spelling game that provides rewards in the form of medals or awards to the winner(s) of the game. Further, there is a long-felt need in the art for a spelling game that can be played with friends and family for fun while improving spelling skills. Finally, there is a long-felt need in the art for an educational game that is capable of offering fun and entertainment while improving spelling skills of the people playing the game.

The subject matter disclosed and claimed herein, in one embodiment thereof, comprises a spelling game. The spelling game provides an entertaining game while allowing the participants to improve their spelling skills. The game features a set that has a plurality of playing cards, with each card having one spelling word printed thereon, and a holder for holding the plurality of playing cards so as to allow users to easily pick a single card. A timer is configured for fifteen seconds, and a buzzer is provided for producing an alert sound. The buzzer is activated by pressing a touch button positioned thereon. A plurality of medals serve as rewards for the winner(s) of the game. The playing set is used by a plurality of individuals participating in the game. In use, a first player picks a playing card and calls out the word printed on the picked playing card and simultaneously activates the timer. Then, a second player, preferably the individual to the immediate right of the first player where more than two individuals are involved in the game, upon activation of the timer, spells out the announced word and the second player wins if he or she provides the correct spelling before the fifteen seconds has lapsed. Otherwise, the first player wins if the spelling by the second player is incorrect or after the fifteen seconds has expired. The winner of the round receives a medal or other award. The game can be played in multiple rounds, determined in advance by the players before the start of the game, and then the individual with the most wins at the end of the number of rounds is the recipient of the award or medal.

In this manner, the novel spelling game of the present invention accomplishes all of the foregoing objectives and provides users with a game and a set of accessories capable of offering fun and entertainment while teaching the participants how to spell. The game creates a competitive atmosphere and enables people between the ages 13 and up to improve their spelling skills while competing with others in an exciting game. The game includes a buzzer and timer to increase urgency and enables players to earn medals or other prizes on winning individual games, a series of games or a tournament.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an educational game for saying and learning the spelling of words. The educational game further includes a playing set having a plurality of playing cards, with each card having a front surface and a rear surface. The front surface having at least one word printed thereon and each card representing a different word. Different card decks can be provided, such as words having a single syllable, two syllables and multiple syllables, to increase the challenge of the game depending on the age or educational level of the participant. A holder or container is provided for holding the plurality of playing cards, and a timer configured to run for different intervals of time, from five seconds to 30 seconds with about 15 seconds being preferred. The timer increment can again be set depending on the skill level of the players. A push button is positioned on the timer to start the counter, and a buzzer for producing an audible sound if provided to signal the end of the allotted time. A plurality of medals or prizes which serve as rewards for the winners of the game. At least two players use the game set and any number of individuals may participate. A first player picks a playing card and announces the word printed on the picked playing card and simultaneously activates the timer to start the timer interval. A second player begins attempting to spell the word upon activation of the timer and tries to spell out the word in play. The second player wins if the word is spelled correctly before the allotted time has lapsed or the first player, or the individual announcing the word, wins if the spelling by the second or challenged player is incorrect or after the allotted time has elapsed. The winner receives a medal or other prize at the conclusion of the round, after a pre-determined number of rounds, or upon completion of the deck that is currently in play.

In yet another embodiment, the second player skips or passes on the opportunity to spell the word called out by the first player when the word is too difficult.

In yet another embodiment, the first player activates the buzzer when the spelling by the second player is incorrect.

In yet another embodiment, a method for learning and improving spelling skills is described. The method includes the steps of initially picking, by a first individual, at least one playing card from a card holder in which the playing card shows a word to challenge the spelling skill of another player. The first player announces the word shown on the playing card and the first player activates a timer for counting down an allotted time. Then a second player, after hearing the word and the activation of the timer, provides a spelling of the enunciated word. The first player checks the spelling of the word uttered by the second player. The first player activates a buzzer either upon the incorrect spelling, the correct spelling, or after lapse of the allotted time.

In yet another embodiment, the method further includes a step of providing a medal to the first user when the spelling by the second user is incorrect.

In yet another embodiment, the method further includes providing a medal to the second user when the spelling by the second user is correct and before lapse of the allotted time.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the playing set of the educational game of the present invention in accordance with the disclosed architecture;

FIG. 2 illustrates a front surface and a rear surface of an exemplary playing card of one potential embodiment of the game set of the present invention in accordance with the disclosed architecture;

FIG. 3 illustrates a perspective view of a plurality of players playing one potential embodiment of the language game of the present invention in accordance with the disclosed architecture; and

FIG. 4 illustrates a flow diagram of one potential method of playing the educational game of the present invention with a plurality of players and in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an educational game that allows people of all ages to learn to spell. There is also a long-felt need in the art for an educational game that provides an exciting format for people to improve their spelling skills while competing with others. Additionally, there is a long-felt need in the art for an educational spelling game that invokes a sense of urgency, competitiveness, and desire to correctly spell words. Moreover, there is a long-felt need in the art for an educational game that provides rewards in the form of medals or other prizes to winners of the game. Further, there is a long-felt need in the art for an educational game that can be played with friends and family for fun while improving spelling skills. Finally, there is a long-felt need in the art for an educational game that is capable of offering a format that is fun and provides entertainment while checking and improving the spelling skills of the people involved in and listening to the game.

The present invention, in one exemplary embodiment, is a method for learning and improving spelling skills using a language game set. The method includes the steps of providing a playing set, having a set of cards, and then picking, by a first player, at least one playing card from a card holder containing the set of cards and the playing card shows a word for spelling. Announcing the word by the first user, and activating, by the first player, a timer for counting down an increment of time, ranging from five to 30 seconds which can be selected in five second increments. The second player begins to spell the announced word, upon activation of the timer; and then checking, by the first player, the spelling of the word uttered by the second player. The first player activates a buzzer either upon incorrect spelling, correct spelling, or after lapse of the allotted time. Then in a further step, starting the next sequence or round of the game. In a further step, a user may pass on the announced word and allow another player to spell the word.

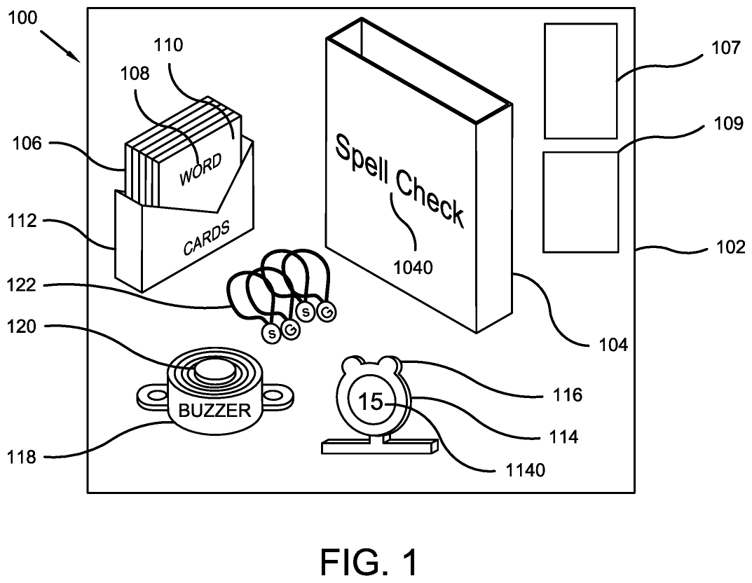

Referring initially to the drawings, FIG. 1 illustrates a perspective view of a playing or game set of the educational game of the present invention in accordance with the disclosed specification. The spelling game 100 is provided in an entertaining and fun format that is designed for people of all ages to provide learning support for improving the spelling skills of the participants. The game 100 can be played by two or more players allowing them to learn the spelling of words, not only by actually spelling the words but by others that may be participating and learning the words while waiting for their turn or observing the game. The spelling game 100 includes a game or playing set 102 that is used by players involved in the spelling game 100. The set 102 is contained in a cardboard box 104, the box 104 is preferably square or rectangular, however, the box 104 can be of any geometric shape. The box 104 can have a name or logo 1040 representing the spelling game. The box is configured for retail sales as well as for online applications.

The set 102 further includes a plurality of playing cards 106. Additional card sets 107 and 109 may also be included in the kit or box set 102. Each card set 106, 107 and 109 may be made up of cards having words of increasing difficulties, such as one set has one syllable words, another set had two syllable words and a third set has three syllable words. The set or box 102 may contain other card sets, such as those which are phonetically challenging and may be more difficult to spell as certain letters of the words may be silent in a pronunciation. In addition, card sets may be provided in different themes, such as animal names, places, or other categories that may make the game more interesting to play.

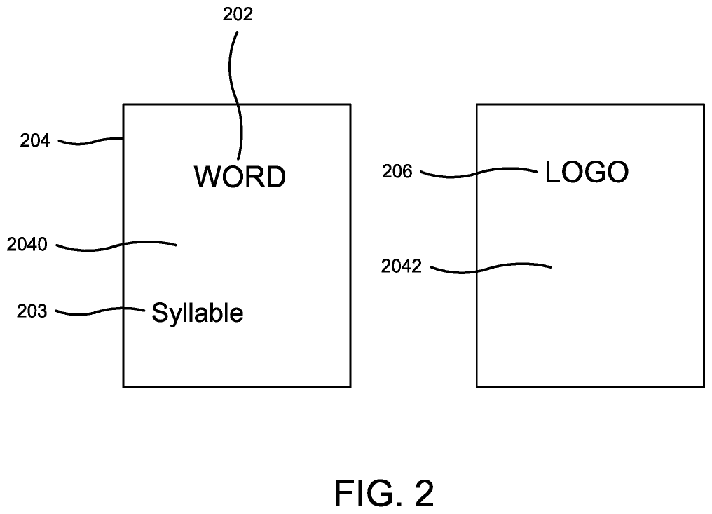

Each card has a different spelling word 108 printed on corresponding front surface 110. Details of the playing cards are described in FIG. 2. A playing cards holder 112 is designed to hold the playing cards 106 allowing a player to easily pull a single card from the deck of the playing card set 106. The set 102 also has a timer 114 and a buzzer 118. The timer 114 is configured to count down different increments in seconds and is activated by pushing the push button 116 positioned on top of the timer 114. The timer 114 may be set in increments of five seconds and ranging from five to 30 seconds with about 15 second being preferred. The timer 114 is manually activated by a player for counting down the seconds. The timer 114 has a pause feature so that the timer may be paused briefly if the player decides to pass during his or her turn. Specifically, the timer 114 counts down the seconds of the time limit allotted for a player to attempt to spell a word for winning a game. The timer 114 has a visible display 1140 for displaying the countdown time for users and may also have an audible ticking sound so that the players can hear the seconds ticking off. The buzzer 118, with an activation button 120, is used for producing an audible alert sound in situations where an incorrect spelling has occurred by a player as described later in the disclosure.

A plurality of medals or other prizes 122 made of plastic, metal and the like are a part of the game set 102 and are used as a reward for players winning the game. A player winning the game may get a gold medal, a runner up may get a silver medal when a plurality of players play the spelling game 100. Optionally, the game set can include a scoring sheet and a writing implement such as a pen, pencil or marker (not shown) for noting down the score of the game.

In the preferred embodiment, the game set 102 may have about 50-60 playing cards allowing players playing the game 100 to learn the spelling of a number of words. Further, the game 100 can be played between at least two players, wherein the players can take turns picking a playing card one by one and let the other players correctly spell the word printed on the playing card.

FIG. 2 illustrates a front surface and a rear surface of an exemplary playing card of the game set 102 of the present invention in accordance with the disclosed specification. As illustrated, the front surface 2040 of the card 204 has a spelling “word” 202 printed thereon. The “word” is a single syllable word. The word 202 can alternatively be embossed or removably attached to the front surface 2040. A multiple syllable word 203 is shown in that the card can have different skill words on the same card or different skill words can appear on different card sets. For playing the game, the card is held by a player announcing the word 202 with the interior of the card towards him or her such that the word 202, which is the subject of the spelling challenge, is not visible to other players. The rear surface 2042 does not have any word and may have a logo or indicia 206 and can have any print or design and the card is preferably not see through. The playing cards have a thickness ranging from about 147 GSM to about 640 GSM or 67 lb Bristol stock to 236 lb cover stock. Each playing card may be coated with an antimicrobial coating to reduce the chance of germs being transferred between players during a game.

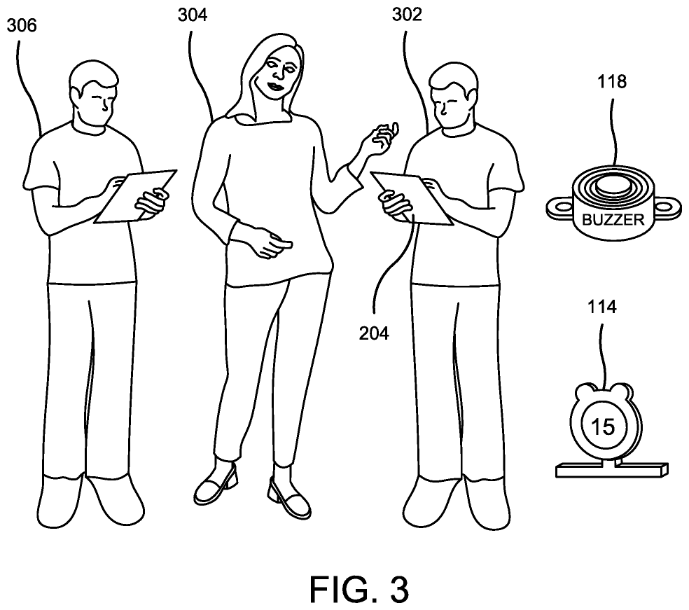

FIG. 3 illustrates a perspective view showing a plurality of individuals playing the educational language game 100 of the present invention using the game set 102 in accordance with the disclosed specification. Prior to playing the spelling game 100, a plurality of players as shown in FIG. 3 are required. Preferably, at least two players are required for playing the game. To begin, a first player 302 picks a playing card 204 from the holder such that the front surface 2040 of the card 204 is hidden from the other players 304, 306. The word written on the front surface 2040 is announced by the first player 302 and the next player i.e., the second player 304 is challenged to spell the word. The first player 302 also activates the timer 114 to start a predetermined amount of time, such as 15 seconds. The spelling of the word by the second player 304 is checked by the first user/player 302 by using the card, and if the spelling is determined to be correct and within the allotted time, then, the second player 304 is declared as winner of the round. As an example, if the spelling of the word by the second user 304 is found to be incorrect, then, the third user 306 is allowed to spell the word and the timer 114 is activated again by the first player 302. As a rule, a player to the right of the player announcing a word written on a playing card is chosen first to spell out the word. Then, the player, moving in a clockwise direction, who spells out the word correctly, has the next turn for picking a playing card for calling out the printed word.

It should be noted that the buzzer 118 is activated by the player who announces the word when the word spelled out by another player is incorrect. The buzzer 118 notifies all the players about an incorrect spelling or the end of the allotted time period. The scores for each correct spelling can be determined and agreed upon before starting the spelling game 100. The objective of the game is to spell the most words correctly and score points. The winner is the player who spells the most words correctly.

It should be noted that the game set 100 can provide playing cards having words of different difficulty levels and genres. The words can be of a specific language, grade level, category and more for challenging players and making the game more enjoyable and educational. The words may include commonly misspelled words, confusing words and more.

Although, in the present embodiment, individual players are playing the spelling game 100, it should be appreciated that the game 100 can be played by teams in which each team may include at least two players.

In another embodiment of the game, a player can score ten points upon spelling a word correctly and score five points upon spelling a word correctly which is incorrectly spelled earlier by another player.

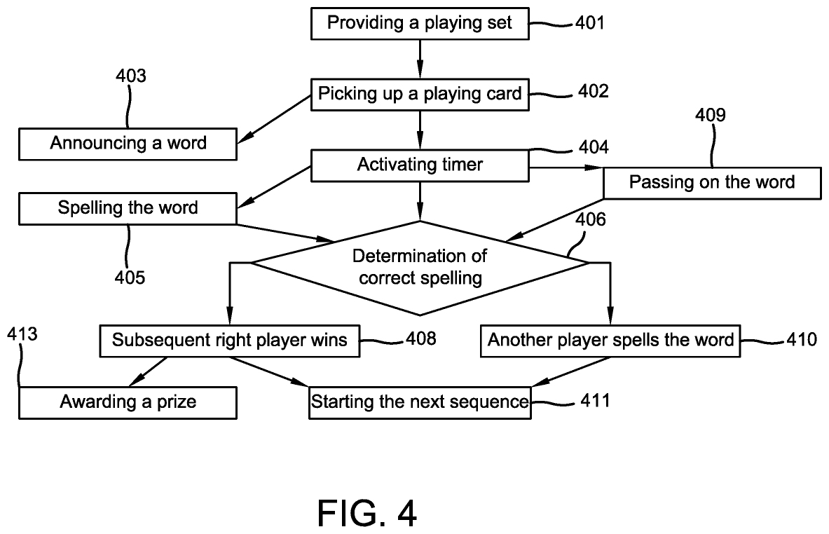

FIG. 4 illustrates a flow diagram of a method of playing the educational game by a plurality of players in accordance with the disclosed specification. Initially, a playing set is provided at step 401. Then, a playing card having a spelling word is picked at step 402 by a first player and announced allowing other players to hear the word clearly (Step 403). Then, the timer is activated by the first player at step 404 and the immediate right player to the first player spells out the spelling of the word (Step 405). Thereafter, it is determined if the spelling by the right player is correct (Step 406). If it is determined that the spelling is correct and is made within the predetermined allocation of time set on the timer, then, the right player wins the round (Step 408). Otherwise, the original challenged player passes at step 409, and the turn to attempt to spell the word correctly moves to another player (Step 410). The game is played continuously by picking up a new card at step 411 by the player winning the round. The game can be played for a predetermined number of rounds (words correctly spelled) by users. In a further step, an award is made at step 413.

It should be understood that the present invention is not limited to playing cards and other objects may also be used. For example, a game set for playing the spelling game may also be made with plastic chips having words printed thereon. Alternatively, the game set may include multiple decks of playing cards arranged by age brackets, subject areas, or both. The game set may also include rules for at least one embodiment of the card game for learning. The rules and the words may be in one or more languages so that the game of the present invention can be enjoyed and utilized worldwide.

It should be understood that the spelling game 100 can be replicated in electronic game form. Representation of the playing cards can be done electronically and graphically via a software program either in a personal computer or stand-alone game device.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “spelling game”, “educational game”, “language spelling game”, and “game” are interchangeable and refer to the language spelling game 100 of the present invention. Also, as used herein “game set”, and “playing set” are interchangeable and refer to the spelling game set 102 of the present invention.

Notwithstanding the foregoing, the spelling game set 102 of the present invention can be of any suitable size and configuration as is known in the art without affecting the overall concept of the invention, provided that it accomplishes the above-stated objectives. One of ordinary skill in the art will appreciate that the spelling game set 102 as shown in the FIGS. are for illustrative purposes only, and that many other sizes and shapes of the spelling game set 102 are well within the scope of the present disclosure. Although the dimensions of the spelling game set 102 are important design parameters for user convenience, the spelling game set 102 can be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An educational game set comprising:
a box for carrying a game set;
at least one set of cards, wherein each card of the at least one set of cards is comprised of a front face and a back face, and further wherein a word is provided on the back face;
a holder;
a timer; and
a buzzer.

2. The educational game set of claim 1, wherein the timer may be set to increments of five seconds.

3. The educational game set of claim 2, wherein the increments range from five seconds to 30 seconds.

4. The educational game set of claim 3, wherein the increment is 15 seconds.

5. The educational game set of claim 1, wherein the word may be a one syllable word, a two syllable word or a multiple syllable word.

6. The educational game set of claim 1, wherein each card of the at least one set of cards has a thickness ranging from about 147 GSM to about 640 GSM.

7. The educational game set of claim 1, wherein each card of the at least one set of cards is comprised of an antimicrobial coating.

8. The educational game set of claim 1, wherein the game set comprises at least three different sets of cards of varying spelling skill sets.

9. The educational game set of claim 1, wherein the at least one card set comprises one of animals, places or phonetically challenging words.

10. The educational game set of claim 1 further comprising a plurality of medals or awards.

11. The educational game set of claim 1, wherein the back face of each card of the at least one set of cards comprises a logo and is opaque.

12. A method of playing an educational game comprising the steps of:
providing a game set having at least one set of cards, a timer and a buzzer, wherein each card of the at least one set of cards is comprised of a front face and a back face;
selecting a card from the at least one set of cards;
announcing a word positioned on the front face of the card selected;
starting a timer;
spelling the word; and
determining a correct spelling of the word.

13. The method as recited in claim 12, wherein the game set further comprises a plurality of awards.

14. The method as recited in claim 12 further comprising a step of passing an opportunity to spell the word after the step of announcing the word.

15. The method as recited in claim 12 further comprising a step of starting another sequence of the method after the step of determining.

16. The method as recited in claim 13 further comprising a step of awarding at least one of the plurality of awards to a player who has correctly spelled the word after the step of determining.

17. The method as recited in claim 12, wherein each card of the at least one set of cards comprises a thickness ranging from about 147 GSM to about 640 GSM and an antimicrobial coating.

18. A spelling game comprising:
a box;
at least one card set comprised of a plurality of cards, wherein each card in the plurality of cards is comprised of a front face and a rear face, and further wherein a word is positioned on the front face;
a holder for the at least one card set;
a timer; and
a buzzer, wherein each of the at least one card set, the holder, the timer and the buzzer are contained within the box until needed.

19. The spelling game as recited in claim 18, wherein the at least one card set comprises a plurality of words having one syllable, two syllables or multiple syllables.

20. The spelling game as recited in claim 18, wherein the at least one card set comprises a plurality of different themes or categories.
